(19) United States
(12) Patent Application Publication
(10) Pub. No.: US 2006/0272019 A1
(43) Pub. Date: Nov. 30, 2006

(54) Intelligent database selection for intrusion detection & prevention systems

(76) Inventor: Srinivasa Rao Addepalli, Cupertino, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/139,221

(22) Filed: May 27, 2005

(51) Int. Cl. G06F 12/14

(52) U.S. Cl. 726/23

(57) ABSTRACT

A method and software for detecting computer system intrusions. More specifically, a method and software for detecting such intrusions by comparing an electronic signal to a database of know intrusion signatures, where the database is chosen based on various characteristics of the signal.

### FIELD OF THE INVENTION

The invention relates to detecting computer system intrusions. More specifically, the invention relates to detecting such intrusions by comparing an electronic signal to a database or data structure of known intrusion and vulnerability signatures, where the database is chosen based on various characteristics of the signal.

### BACKGROUND

Unwanted electronic intrusions into computer systems and networks are a significant and well-documented problem for private, government, and corporate computer users. Such intrusions include, for example, exploitation of vulnerabilities in computer application programs, computer viruses, and a wide range of electronic “parasites” designed to steal confidential information, to convey user profiles to advertisers, or to surreptitiously use the processing power of another machine, among others. An intrusion can lead to various problems ranging from minor decreases in productivity to serious breaches of security and permanent loss of information.

Various methods have been devised to detect and prevent unwanted electronic intrusions, and the resulting systems are generally termed intrusion detection systems (IDS) and intrusion prevention systems (IPS). One method of detecting intrusions is known as pattern matching, and involves comparing an electronic signal pattern to a database of known intrusion patterns. If a match occurs, the signal is classified as an intrusion, and appropriate steps are taken. For instance, the intrusion may be blocked from entering the computer system, or it may be sent to a special electronic “holding area” pending further human or electronic examination.

However, with intrusions on the rise, the number of intrusion patterns that must be compared to every suspect signal is increasing rapidly. This decreases the performance of computer systems, and may even lead to some intrusions not being detected at all. One way to address this problem is by using hardware acceleration techniques to increase the speed of pattern matching, but this generally increases the costs of IDS systems. Therefore, a need exists for a method of improving performance of pattern matching for intrusion detection purposes without relying on hardware acceleration.

### SUMMARY OF THE INVENTION

The invention provides a method of dividing electronic intrusion patterns into a plurality of databases, classifying electronic signals according to various characteristics, and pattern matching a given signal with only those intrusion patterns contained in the databases correlated to the characteristics of the signal.

### BRIEF DESCRIPTION OF THE DRAWINGS

FIG. 1 is a schematic diagram showing hierarchical structure of a plurality of databases of intrusion patterns, according to an embodiment of the invention.

FIG. 2 is a flowchart showing exemplary steps in a pattern matching intrusion detection process, according to an embodiment of the invention.

### DETAILED DESCRIPTION

IDS/IPS systems typically contain two components, which may generally be termed a sensor component and a manager component. The sensor component is primarily designed to detect unwanted intrusions, whereas the manager component is primarily designed to configure the IDS/IPS system and to perform analysis of log files that are accumulated during operation of the system. Typically, the manager component also downloads the latest intrusion signatures from a central server or data repository, and uploads these signatures to the sensor component. Intrusion signatures are compared to network transmitted information.

Information passing in and out of IP networks is formatted as packets. Packets generally have a header section and a data section. The header section contains fields such as the IP address it's going to and the IP address it's originating from. There are protocols for each application associated with the packet, such as SMTP, FTP or HTTP, that defines the number, type, format and location of the fields and data in the packet. Information transfer over an IP network can involve a series of packets as well. Large files or data streams are broken down to a group of packets that are transmitted and reassembled at the receiving client. Some protocols use a series of packets to deal with handshake and security protocols. An SMTP data transfer involves three stages. The first stage establishes a link from the sender to the recipient and sets security information. In the second stage, recipient name sender name and subject are sent and in the final stage the message is sent.

The fields can also define extrinsic information about the packet such as whether the packet is inbound or outbound from a network, or it can be derived from the layer 2 interfaces such as wireless or Ethernet. All of the attributes, fields, content and format of the packet constitute the packet parameters or characteristics.

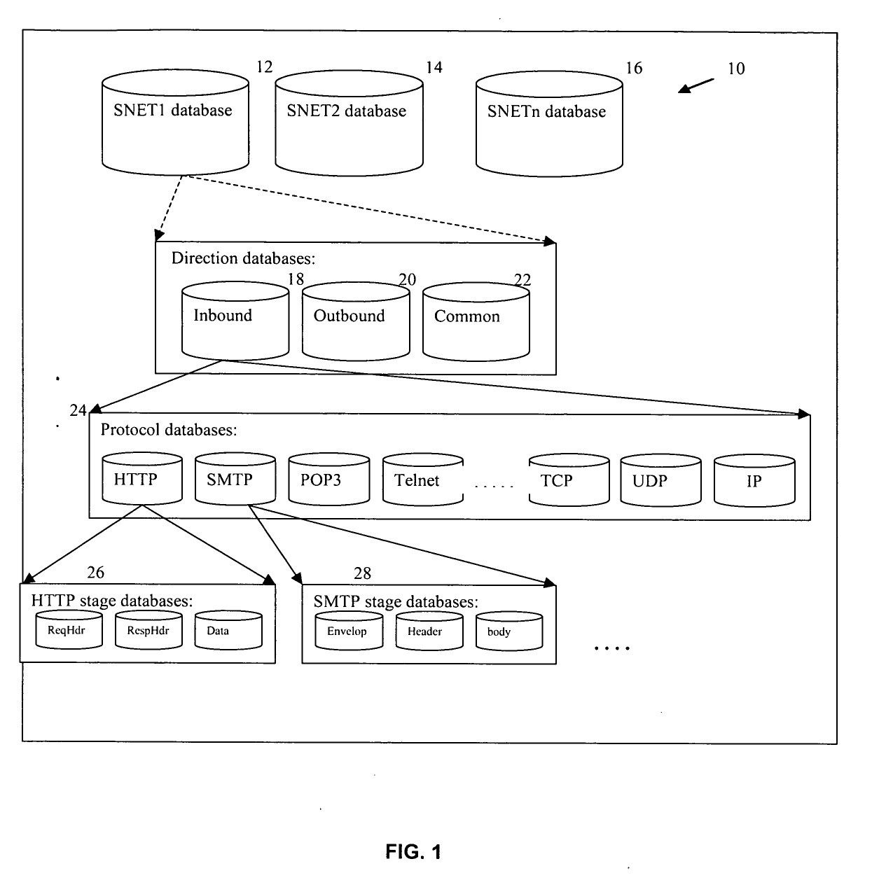

FIG. 1 shows hierarchical structure of a plurality of databases of intrusion patterns (signatures) 10, according to an embodiment of the invention. The database can be any kind of data structure which can index the signatures. The signatures are divided into multiple databases, SNET1 database 12, SNET2 database 14, SNETn database 16, where the manager performs one level of separation, and the sensor performs other levels of separation. The manager may provide flexibility by allowing the human system administrator to manually attach each signature to one or more different networks. For instance, the manager may provide a number of “Security Networks” (SNETs). The system administrator may know the types of servers and applications running on different SNETs, so that the administrator may add appropriate signature comparison rules to the various SNETs.

The sensor typically arranges the signatures for each SNET into multiple databases based on various criteria related to characteristics of the packet being analyzed. For example, as indicated in FIG. 1, the sensor may divide the signatures 10 according to the following criteria:

Direction of the packet: Inbound 18, Outbound 20, or Common 22. Inbound packets are the packets that are directed towards internal networks, outbound packets are packets that are directed away from internal networks, and ‘Common’ means signatures to be considered for both kinds of packets.

Service (application type): Signatures belonging to different services go into different protocol databases 24. Examples of services include HTTP, FTP, Telnet, SMB, SNMP, POP3, IMAP, SMTP, TCP Generic, UDP Generic, IP Generic, and ARP.

Application stage: Each protocol (service) has different stages. For example, HTTP has a request header stage, a response header stage, and a data transfer stage. SMTP has an envelope header stage, a body header stage, and a body data stage. Signatures relating to each stage may be arranged in separate protocol stage databases by the sensor, such as HTTP stage databases 26 and SMTP stage databases 28.

Typical entries into the data structure storing the intrusion patterns will have attribute references for each signature. As an example, entries downloaded from a server of new signatures might look like:

| Pattern | Attr1 | Attr2 | Attr3 |
|---|---|---|---|
| “xyz” | Inbound | HTTP | Body |
| “745” | Both | FTP | Body Header |
| “356” | Outbound | POP3 | Envelope Header |
| “742” | Inbound | SMTP | Body |

A security network dealing only with email would take the last two entries of the download from the server, and add them to the intrusion data structure for the security network. These two are selected since Attr2 fields of POP3 and SMTP are mail attributes. When an inbound SMTP information packet reaches the security network, the intrusion system will acquire all the signatures from the data structure for SMTP packets that are inbound or both inbound and outbound (common). The intrusion system compares the packet stages to the appropriate signatures according to the third attribute. If there is a correlation between the packet and the signature, the packet is appropriately disposed of. This description is for the purposes of illustrating one embodiment of this invention. There may be more or fewer fields in the data structure in other embodiments and will still be within the scope of this disclosure.

In one embodiment of the invention, to facilitate processing, an IDS/IPS system typically associates an IP packet to a TCP/IP session. The session is created upon receipt of the first packet using packet header data which includes source IP address, the destination IP address, the IP Protocol, the source port, and the destination port. The appropriate security network for the session may be identified at the time of creation of the session.

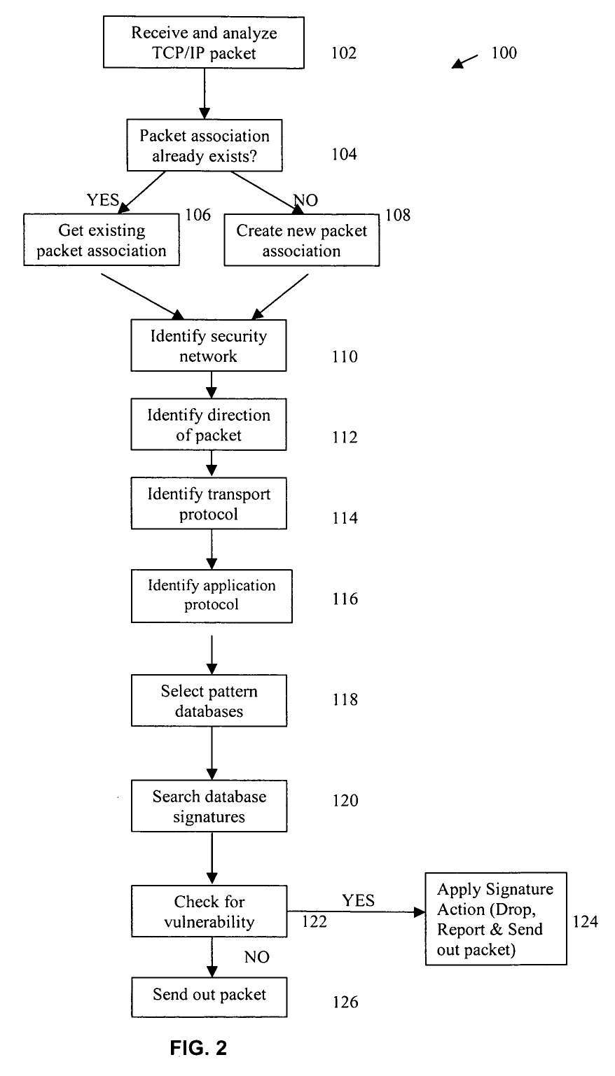

FIG. 2 is a flowchart showing exemplary steps in a pattern matching intrusion detection process 100, according to an embodiment of the invention. As indicated in FIG. 2, upon receipt of a packet 102, the IPS/IDS system will analyze a packet 104 and determine the associated session, if it exists 106. If no session exists for the packet, the system creates a new session 108. The system identifies the security network 110 appropriate for the packet, identifies the direction of the packet (inbound or outbound) 112, identifies the transport protocol associated with the packet 114 (e.g., TCP, UDP, GRE), and identifies the application protocol used for the packet 116 (e.g., HTTP, SMTP, POP3, SNMP). Based on these and/or other characteristics of the packet, the system selects one or more appropriate pattern databases 118, and the intrusion signatures in those databases are searched 120 and compared with the packet content to check for vulnerabilities 122.

If a match between a packet signature and an intrusion signature is detected, appropriate action such as rejection or rerouting of the packet may be performed 124. If no vulnerabilities are found the packet is sent out 126. However, since only certain appropriate databases of intrusion signatures are searched for each type of packet, the system as described above results in improved efficiency and speed of intrusion detection, while still maintaining a desired level of security as set by the system administrator.

The disclosure set forth above may encompass one or more distinct inventions, with independent utility. Each of these inventions has been disclosed in its preferred form(s). These preferred forms, including the specific embodiments thereof as disclosed and illustrated herein, are not intended to be considered in a limiting sense, because numerous variations are possible. The subject matter of the inventions includes all novel and nonobvious combinations and subcombinations of the various elements, features, functions, and/or properties disclosed herein.

We claim:

1. A computer network intrusion detection method comprising the steps of:
retrieving intrusion patterns from a server;
indexing the intrusion patterns by packet parameters;
indexing the information packets by packet parameters; and
identifying information packets matching the at least one intrusion pattern where the intrusion pattern index is correlated to the packet index.

2. The intrusion detection method of claim 1 where the packet parameters include application type.

3. The intrusion detection method of claim 1 where the packet parameters include application stage.

4. The intrusion detection method of claim 1 where the packet parameters include the direction of the packet.

5. A computer network intrusion detection system in which at least one node in a network processes all transmitted data, the node comprising:
memory for storing program instructions and data structures;
program instructions stored in memory written to
retrieve intrusion signatures from a server; and
index the intrusion signatures by packet parameters; and
compare an information packet indexed by packet parameters to the intrusion signatures where the packet index is associated to the signature index; and
classify the information packet; and
at least one processor for executing program instructions stored in the memory.

6. The intrusion detection system of claim 5 where the packet parameters include application type.

7. The intrusion detection system of claim 5 where the packet parameters include application stage.

8. The intrusion detection system of claim 5 where the packet parameters include the direction of the packet.

9. A computer network intrusion detection system comprising:
a plurality of data structures containing intrusion patterns where each data structure holds patterns for a subset of index values; and
a plurality of nodes where each node is associated with at least one data structure;
where the each node and associated data structures define a security network;
where the nodes process substantially all information packets passing in or out of the security network;
where the index values are derived from packet characteristics, IP session characteristics and protocol stages;
where the nodes analyze an information packet by
determining if a session exists for the packet;
selecting a security network;
identifying the packet direction;
identifying the packet transport protocol;
identifying the packet application;
selecting an intrusion signature data structure;
selecting intrusion signatures from the data structure using identified packet parameters;
comparing the packet to the intrusion patterns and classifying the packet.

10. The intrusion detection system of claim 9 where the indexes include application type.

11. The intrusion detection system of claim 9 where the indexes include application stage.

12. The intrusion detection system of claim 9 where the indexes include the direction of the packet.

13. The intrusion detection system of claim 9 where the indexes include body data stage.

14. The intrusion detection system of claim 9 where the indexes include the body header stage.

15. A network intrusion prevention method comprising the steps of:
indexing a database of intrusion signatures by packet parameters;
determining information packet parameters of an information packet transmitted in or out of the network;
indexing a database of intrusion signatures by packet parameters; selecting signatures from the database based on the determined packet parameters;
comparing the packets to the intrusion patterns selected; classifying the packet according to degree of correlation to the intrusion pattern.

16. The intrusion prevention method of claim 15 where the attributes include application type.

17. The intrusion prevention method of claim 15 where the attributes include application stage.

18. The intrusion prevention method of claim 15 where the attributes include the direction of the packet.

19. A memory for storing data for access by a network intrusion detection system comprising:
a data structure stored in said memory said data structure including:
intrusion patterns obtained from a repository;
a plurality of attributes for each pattern where the attributes are parameters associated with a previous transmission of the intrusion pattern in an IP network packet;
where intrusion patterns are selected and correlated to packets and the packets classified;
where the intrusion patterns are selected by reference to the parameters of the packet.

20. The memory of claim 19 where the attributes include application type.

21. The memory of claim 19 where the attributes include application stage.

22. The memory of claim 19 where the attributes include the direction of the packet.

23. A network intrusion detection system comprising:
a security network where the at least one network computer performs at least one specialized function;
a database containing a subset of intrusion signatures downloaded from a central server where the intrusion signatures are associated with the at least one specialized function;
where information packets associated with the at least one specialized function are compared to the intrusion signatures of the at least one specialized function and dispositioned based on the degree of correlation.

24. The network intrusion system of claim 23 where a specialized function is as a mail server.

25. The network intrusion system of claim 23 where a specialized function is as an HTTP server.

26. The network intrusion system of claim 23 where a specialized function is telnet.

27. The network intrusion system of claim 23 where a specialized function is FTP.
